(19) United States
(12) Patent Application Publication
(10) Pub. No.: US 2026/0039209 A1
(43) Pub. Date: Feb. 5, 2026

(54) LLC CONVERTER WITH ENVELOPE CONTROL

(71) Applicant: AES Global Holdings PTE Ltd., Singapore (SG)

(72) Inventors: Shi Jie Deng, Shenzhen (CN); Peng Wu, Yueyang City (CN); Jiang Liu, Shenzhen (CN)

(21) Appl. No.: 19/100,006

(22) PCT Filed: Aug. 2, 2022
(86) PCT No.: PCT/CN2022/109641

§ 371 Date: Jan. 30, 2025

(51) Int. Cl. H02M 3/335; H02M 3/00

(52) U.S. Cl. CPC H02M 3/33569; H02M 3/01

(57) ABSTRACT

A control circuit for a power converter includes a plurality of power switches, a resonant network coupled with the plurality of power switches, and an output circuit coupled with the resonant network. The control circuit comprises a sampler configured to sample an output voltage provided by the output circuit to generate a sampled output voltage and a feedback signal mixer configured to mix the sampled output voltage with a reference voltage to generate a mixed feedback signal. An envelope controller is configured to generate an envelope signal based on a sensed current flowing through the resonant network and generate a clock signal based on the mixed feedback signal and the envelope signal. A drive module is configured to generate a plurality of drive signals based on the clock signal and control the plurality of power switches based on the plurality of drive signals.

### CROSS-REFERENCE TO RELATED APPLICATIONS

This 371 national stage application claims the benefit of and priority to PCT Application No. PCT/CN2022/109641, filed Aug. 2, 2022. The entire disclosure of the above application is incorporated herein by reference.

### TECHNICAL FIELD

Embodiments of the present disclosure relate to power supplies and, more particularly, to controlling LLC power converters using envelope control.

### BACKGROUND

Resonant LLC converter topology is widely used due to its zero-voltage-switching (ZVS) capability, low-voltage stress, high efficiency performance, and its ability to achieve high power density. Being able to realize ZVS in both primary side switches as well as secondary side switches provides advantages in conversion efficiency and control of electromagnetic interference.

An LLC converter adjusts the output voltage by changing switching frequency. Known control methods for handling switching frequency changes via a controlled oscillator (e.g., a controller) can include direct frequency control (DFC) and current mode control (CCM). A typical DFC has only one control terminal, which is the output voltage. A typical CCM includes the output voltage control signal similar to DFC and has an additional control terminal, which is the resonant inductor current.

The DFC can be easy to implement, but it may be difficult to improve system control bandwidth, and the dynamic performance and the ability to suppress the input low-frequency ripple may be undesirable. The CCM adds additional hardware and requires a controlled current source. In addition, during multi-phase operation, current sharing performance may be undesirable.

### SUMMARY

In accordance with one aspect of the present disclosure, a control circuit for a power converter includes a plurality of power switches, a resonant network coupled with the plurality of power switches, and an output circuit coupled with the resonant network. The control circuit comprises a sampler configured to sample an output voltage provided by the output circuit to generate a sampled output voltage and a feedback signal mixer configured to mix the sampled output voltage with a reference voltage to generate a mixed feedback signal. An envelope controller is configured to generate an envelope signal based on a sensed current flowing through the resonant network and generate a clock signal based on the mixed feedback signal and the envelope signal. A drive module is configured to generate a plurality of drive signals based on the clock signal and control the plurality of power switches based on the plurality of drive signals.

In accordance with another aspect of the present disclosure, a method for generating a plurality of control signals for a power converter comprises sampling an output voltage generated by an output circuit of the power converter, generating a sampled output voltage based on the sampled output voltage, mixing the sampled output voltage with a reference voltage, and generating a mixed feedback signal based on the mixed sampled output voltage. The method also comprises generating an envelope signal based on a sensed current flowing through a resonant network of the power converter, generating a clock signal based on the mixed feedback signal and the envelope signal, and generating a plurality of drive signals based on the clock signal.

In accordance with another aspect of the present disclosure, a power converter comprises a transformer, a switching bridge circuit, a resonant tank circuit, an output rectifier, and a controller. The transformer comprises a primary winding coupled to a primary side of the power converter and a secondary winding coupled to a secondary side of the power converter. The switching bridge circuit is on the primary side and comprises a voltage input configured to receive a first voltage and a plurality of switches, each switch controllable into a conduction mode and into a non-conduction mode. The resonant tank circuit is on the primary side and is coupled to the switching bridge circuit. The output rectifier is coupled to the secondary winding and comprises a voltage output configured to output an output voltage. The controller is configured to sample the output voltage to generate a sampled output voltage, mix the sampled output voltage with a reference voltage, generate a mixed feedback signal based on the mixed sampled output voltage, and generate an envelope signal based on a sensed current flowing through the resonant tank circuit. The controller is further configured to generate a clock signal based on the mixed feedback signal and the envelope signal and generate a plurality of drive signals based on the clock signal to control the conduction modes of the plurality of switches.

### BRIEF DESCRIPTION OF THE DRAWINGS

The drawings illustrate embodiments presently contemplated for carrying out the invention.

In the drawings:

FIG. 1 is a circuit block diagram illustrating a power converter according to an example.

FIG. 2 illustrates a resonant half-bridge LLC converter with an envelope controller according to an example.

FIG. 3 illustrates a sampling hardware implementation according to an example.

FIG. 4 illustrates a filter hardware implementation according to an example.

FIG. 5 illustrates the envelope controller of FIG. 2 according to an example.

FIG. 6 illustrates a limiter hardware implementation according to an example.

FIG. 7 illustrates a clock generator hardware implementation according to an example.

FIG. 8 is a signal processor circuit according to an example.

FIG. 9 is a signal processor circuit according to another example.

FIG. 10 is a signal processor circuit according to another example.

FIG. 11 is a signal processor circuit according to another example.

FIG. 12 illustrates waveforms according to an example.

FIG. 13 illustrates a current feedback circuit according to an example.

FIG. 14 illustrates a current feedback circuit according to another example.

FIG. 15 illustrates a current feedback circuit according to another example.

FIG. 16 illustrates a current feedback circuit according to another example.

FIG. 17 illustrates a current feedback circuit according to another example.

FIG. 18 illustrates a power converter according to another example.

FIG. 19 illustrates a power converter according to another example.

FIG. 20 illustrates a power converter according to another example.

While the present disclosure is susceptible to various modifications and alternative forms, specific embodiments thereof have been shown by way of example in the drawings and are herein described in detail. It should be understood, however, that the description herein of specific embodiments is not intended to limit the present disclosure to the particular forms disclosed, but on the contrary, the intention is to cover all modifications, equivalents, and alternatives falling within the spirit and scope of the present disclosure. Note that corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

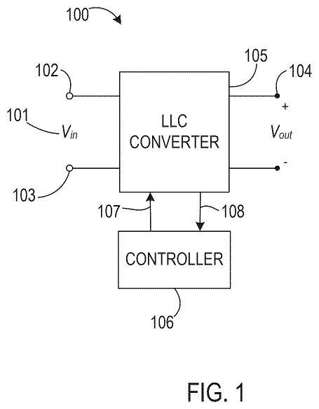

FIG. 1 illustrates a circuit block diagram of a power converter 100 according to an embodiment. The power converter 100 receives an input voltage via a voltage input 101 having input terminals 102, 103 and converts the received voltage to an output voltage for supply to a load via a voltage output 104. The power conversion is implemented according to aspects disclosed herein using an LLC converter 105.

The power converter 100 also includes a controller 106 for controlling one or more power switches (e.g., metal-oxide-semiconductor field-effect transistors (MOSFETs)) in the power converter 105. For example, the controller 106 may generate one or more control signals 107 for controlling the power switches of the LLC converter 105 for generating a target output voltage. The control signals 107 may be generated based on a sensed parameter 108 (e.g., a resonant network current) of the power converter 100 as described herein.

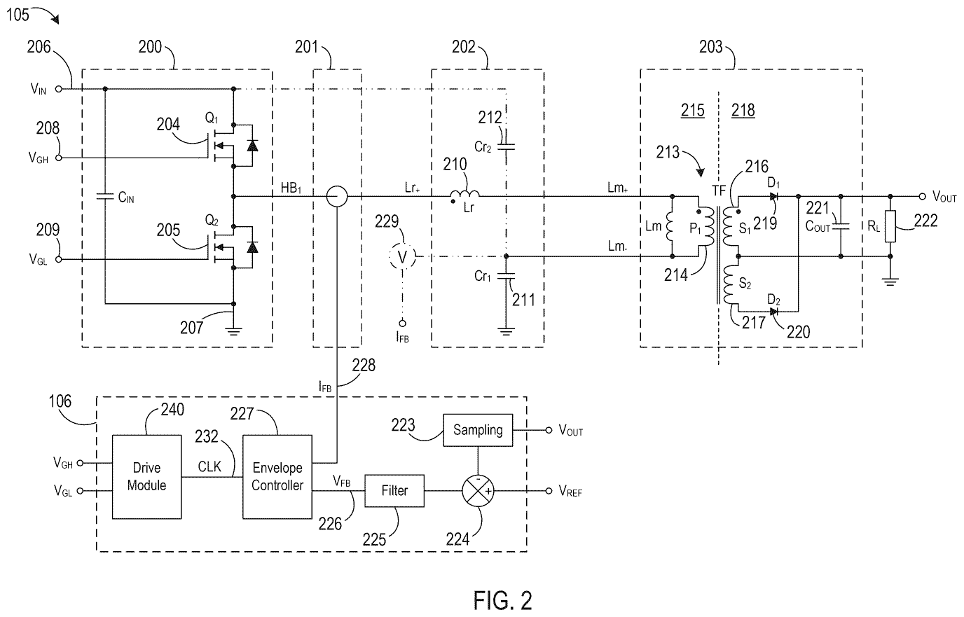

FIG. 2 illustrates an example of the LLC converter 105 of FIG. 1 circuit according to an embodiment of the present disclosure. The LLC converter 105 includes a voltage chopper 200, a current feedback sensor 201, a resonant network 202, and an output rectifier 203.

Voltage chopper 200 includes two power semiconductor switches: a high-side switch 204 and a low-side switch 205. As illustrated in FIG. 2, the switches 204, 205 are active switches and include transistors (e.g., metal oxide semiconductor field-effect transistors (MOSFETs)). Embodiments of the disclosure, however, contemplate the use of alternative actively controlled switches, passive switches, and the like for either or both switches. The switches 204, 205 are connected in series between a first voltage 206 (e.g., V₁) and a circuit ground 207. The switches 204, 205 are turned on (e.g., into a conduction mode) and off (e.g., into a non-conduction mode) by their respective gate driver signals 208 (V_{GH}), 209 (V_{GL}) driven by the controller 106 configured to generate the respective PWM signals V_{GH}, V_{GL} to drive each gate driver circuit 208, 209. Generation of the control signals V_{GH}, V_{GL} are described below with respect to the controller 106.

The resonant network 202, coupled with the voltage chopper 200 includes a resonant inductor 210 and one or more resonant capacitors 211, 212. The resonant capacitor 212 is shown in phantom to illustrate that it may or may not be included in the LLC converter 105.

The output rectifier 203, coupled with the resonant network 202 includes a transformer 213 having a primary winding 214 on a primary side 215 and one or more secondary windings 216, 217 on a secondary side 218. As illustrated in FIG. 2, the secondary windings 216, 217 are coupled to a pair of diodes 219, 220 and an output capacitor 221 in a full-wave rectifier arrangement. While two secondary windings 216, 217 are shown, a single center-tapped winding may be alternatively used in the full-wave rectifier arrangement. A load 222 is coupled with the output rectifier 203 and is represented by the resistor R_{L}.

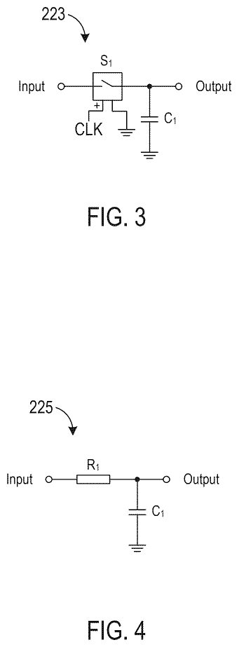

As described above, the PWM control signals V_{GH}, V_{GL} are generated by the controller 106, which generates the signals V_{GH}, V_{GL} based on feedback signals from the LLC converter 105. A first feedback signal V_{OUT} is received by the controller 106 and is sampled by a sampling block 223. In one example, the sampling block 223 may be implemented by a digital signal processor (DSP), a microcontroller (MCU), or the like via an analog-to-digital (ADC) module thereof. In another example, the sampling block 223 may be implemented via the circuit illustrated in FIG. 3. The sampled output voltage V_{OUT} is subtracted from a reference voltage V_{REF} by a feedback signal mixer 224 and filtered by a filter block 225 to generate a voltage feedback signal VFB 226 provided to an envelope control block 227. In one example, the filter block 225 may be implemented by a DSP/MCU via an infinite impulse response (IIR) filter module thereof. In another example, the filter block 225 may be implemented via the circuit illustrated in FIG. 4.

The sampling block 223, mixer 224, and filter block 225 form a voltage loop to stabilize the output voltage V_{OUT}. The reference voltage V_{REF} provides the target value of the output voltage V_{OUT}. The mixed signal created by the subtraction of the sampled output voltage V_{OUT} from the reference voltage V_{REF}, which indicates the error value of the output voltage and then sent to the filter block 225 to complete the compensation of the voltage loop.

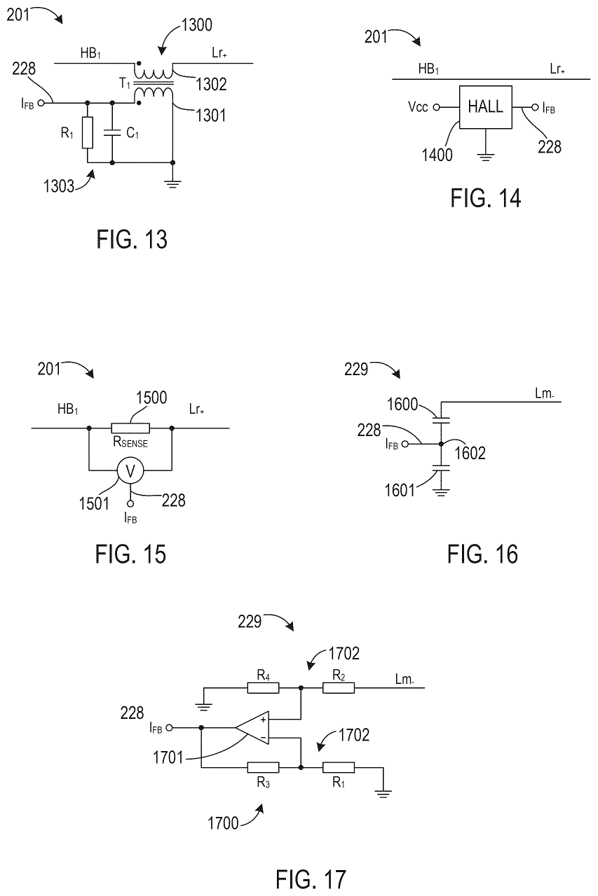

The envelope control block 227 also receives as input a current feedback signal 228 representing the current flowing through the resonant network 202. As illustrated, the current feedback sensor 201 coupled between the voltage chopper 200 and the resonant inductor 210 may provide the current feedback signal 228 to the envelope control block 227. The current feedback sensor 201 may provide a voltage to the envelope control block 227 indicative of the amount of current flow passing through the resonant inductor 210 and/or the resonant network 202. An alternative current feedback sensor 229 shown in phantom may be used to provide the current feedback signal 228 as a value of the voltage across the resonant capacitor 211. FIGS. 13-17 (discussed below) illustrate examples of the current feedback sensors 201, 229 according to embodiments.

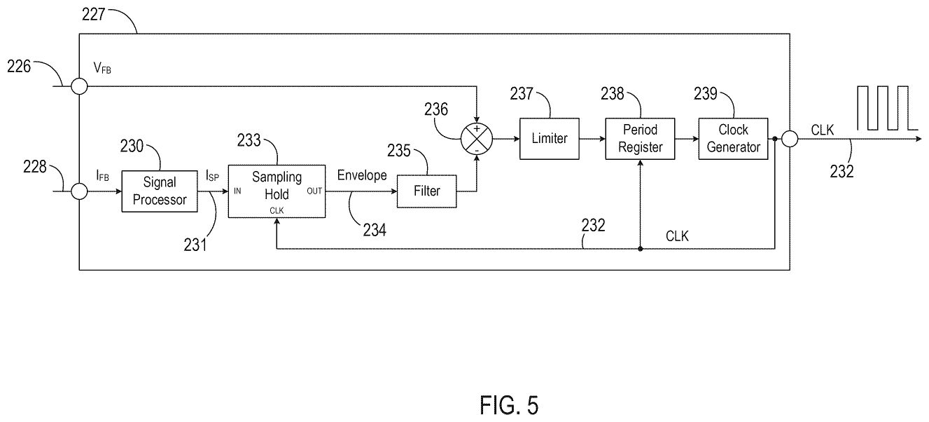

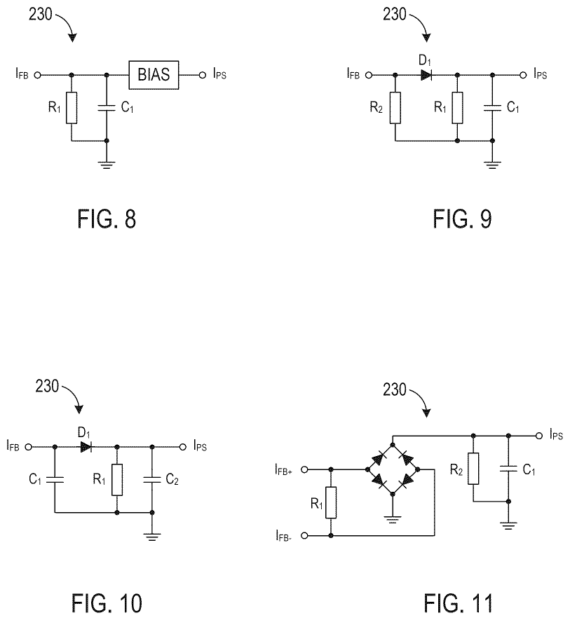

A schematic implementation of the envelope control block 227 is illustrated in FIG. 5. As shown, the current feedback signal 228 is received and processed by a signal processor block 230 configured to obtain a suitable phase or level of the current feedback signal 228. The signal processor block 230, therefore, generates a phase-shifted or level-shifted current signal Isp 232 based on the input current feedback signal 228. Generating the phase shift signal allows the sampling to happen more conveniently. FIGS. 8-11 illustrate exemplary embodiments for shifting the phase or level of the current feedback signal 228 according to embodiments. For example, the signal processor block 230 illustrated in FIG. 8 can obtain a phase shift signal, and it is convenient to use the rising/falling edge the of clock signal 233 as the sampling trigger point of a sample-and-hold block 231 (see FIG. 5) to sample the signal processor signal I_{SP} 232 used in forming an envelope signal. The circuits illustrated in FIGS. 9-11 are different envelope detection circuits that can directly provide envelope signals and a phase-shift is not necessary. Thus, the sampling trigger point of the sample-and-hold block 231 can be set at any point in the switching cycle.

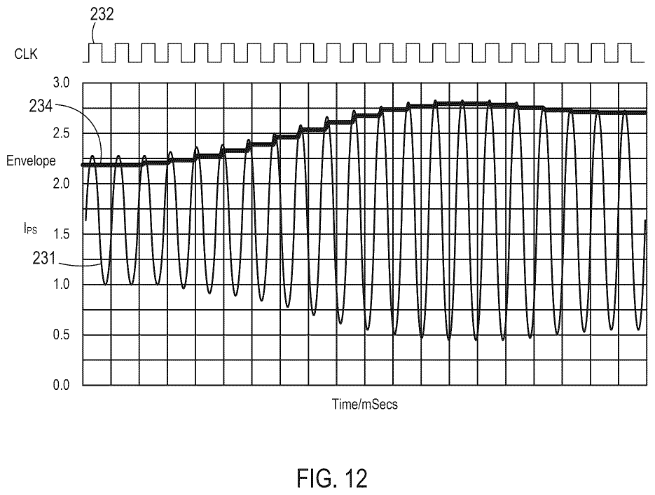

Referring to FIGS. 5 and 12, the signal processor current signal Isp is provided to a sample-and-hold block 231 to generate an envelope of the signal. The sample-and-hold block 231 may be implemented as described herein with respect to sampling block 223 and receives the phase-shifted or level-shifted current signal Isp 232, and the clock signal 233 generated by the sample-and-hold block 231 as a feedback input. In one embodiment, based on a rising or falling edge of the clock signal 233, the Isp signal 232 is sampled and held until the next sampling time (e.g., the next rising clock signal edge). As described above, when based on a phase shifting of the current feedback signal 228 using, for example, the circuit illustrated in FIG. 8, the envelope signal 234 should be determined from the signal 232 through a specific sampling trigger point on the sample-and-hold block 231. Thus, the clock signal is fed back to the sample-and-hold block 231 to produce a sampling trigger point. The sampled signal generates the envelope signal 234 output by the sample-and-hold block 231 and supplied to a filter block 235 that filters out high-frequency signals from the envelope signal 234. The filter block 235 may be implemented as described herein with respect to filter block 225.

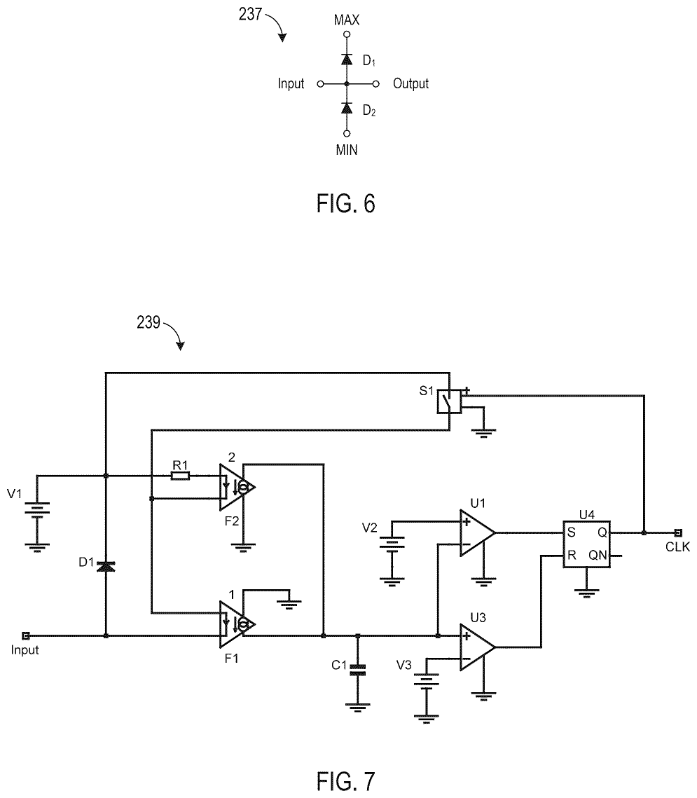

As shown in FIG. 5, the filtered envelope signal is subtracted from the voltage feedback signal V_{FB} 226 via an envelope signal mixer 236 and supplied to a limiter 237, which clamps a maximum/minimum value of the signal. In one example, the limiter 237 may be implemented by a DSP/MCU via an limiter function module thereof. In another example, the limiter 237 may be implemented via the circuit illustrated in FIG. 6. A period register 238 is used to update the clamped period value to within a predetermined range. In one example, the period register 238 may be implemented by a DSP/MCU via a data register module thereof. In another example, the period register 238 may be implemented via a controlled signal. The period register 238 supplies the resulting signal to a clock generator 239 that generates the clock signal 233. In one example, the clock generator 239 may be implemented by a DSP/MCU via a PWM module thereof to generate the clock signal. In another example, the clock generator 239 may be implemented via the circuit illustrated in FIG. 7.

Referring back to FIG. 2, the clock signal 233 is provided to a drive module 240, which generates the gate driver signals 208, 209 via, for example, a driver IC and supporting peripheral hardware circuits.

FIGS. 13-15 illustrate exemplary current feedback circuits for the current feedback sensor 201 of FIG. 2 according to embodiments. FIG. 13 illustrates a current transformer 1300 having a secondary winding 1301 coupled with a primary winding 1302 inline with the current flowing through the resonant inductor 210 (FIG. 2). The resonant inductor current flowing through the primary winding 1302 generates a coupled current flowing through the secondary winding 1301, which generates the current feedback signal 228 across a parallel resistor/capacitor network 1303. FIG. 14 illustrates a hall-effect sensor 1400 positioned adjacently to the path between the voltage chopper 200 and the resonant inductor 210 to sense the magnetic field generated by the current flowing through the resonant inductor 210. The current feedback signal 228 is output by the hall-effect sensor 1400. FIG. 15 shows a sense resistor 1500 coupled inline with the path between the voltage chopper 200 and the resonant inductor 210 and a voltage sensor 1501 coupled to sense a voltage across the resistor 1500 generated by the current flowing through the resonant inductor 210. In one embodiment, the voltage sensor 1501 may be a differential voltage comparator such as that shown in FIG. 17.

FIGS. 16-17 illustrate exemplary current feedback circuits for the current feedback sensor 229 of FIG. 2 according to embodiments. As illustrated in FIG. 16, a capacitor divider having a pair of capacitors 1600, 1601 provides, at the node 1602 between the capacitors 1600, 1602, a voltage indicative of the current flowing through the resonant inductor 210. FIG. 17 illustrates a differential voltage comparator 1700 coupled to sense the voltage across the resonant capacitor 211 (see FIG. 2). The differential voltage comparator 1700 includes an opamp 1701 and a resistor network 1702 coupled to the inputs of the opamp 1701. The output of the opamp 1701 provides a voltage indicative of the current flowing through the resonant inductor 210.

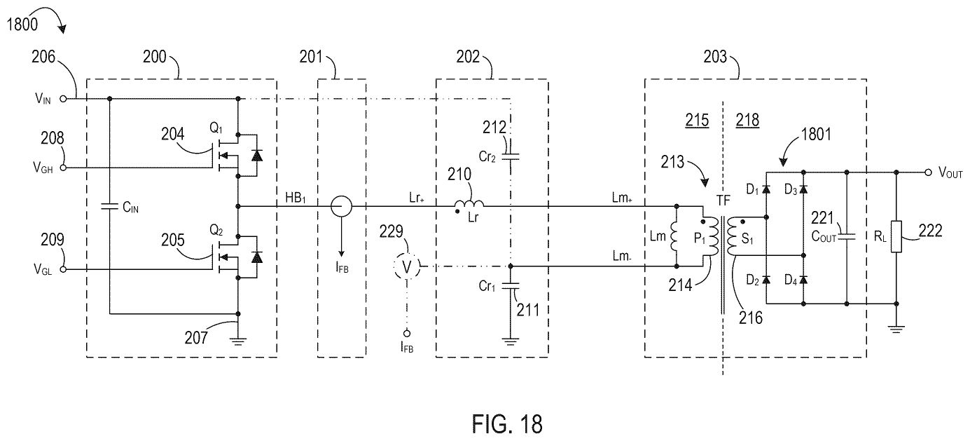

FIG. 18 illustrates an LLC converter 1800 with an alternative circuit for the output rectifier 203 compared with the LLC converter 105 illustrated in FIG. 2 according to an embodiment. The output rectifier 203 of FIG. 18 includes a full-bridge diode assembly 1801 coupled with the secondary winding 216 of the primary winding 214. The full-bridge diode assembly 1801 is coupled in parallel with the output capacitor 221 and the load 222.

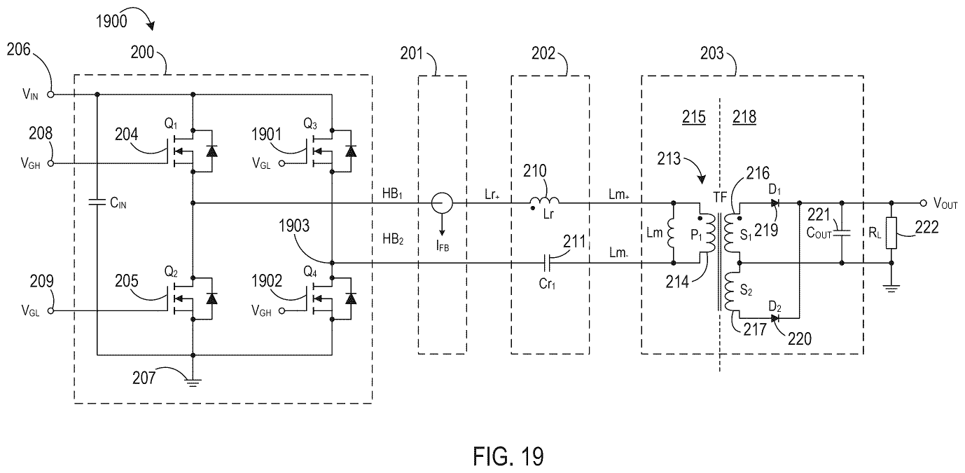

FIG. 19 illustrates an LLC converter 1900 with an alternative circuit for the voltage chopper 200 compared with the LLC converter 105 illustrated in FIG. 2 according to an embodiment. The voltage chopper 200 of FIG. 19 includes four power semiconductor switches in a full-bridge arrangement. Additional high-and low-side switches 1901, 1902 are provided in a series-coupled arrangement in parallel with the series-coupled arrangement of the high-and low-side switches 204, 205. In addition, instead of being coupled with the circuit ground 207 as shown in FIG. 2, the resonant capacitor 211 (see FIG. 2) is coupled with the node 1903 between the high-and low-side switches 1901, 1902. Control of the switches is arranged so that the high-side switch 204 and the low-side switch 1902 are turned on and off together and the high-side switch 1901 and the low-side switch 205 are turned on and off together.

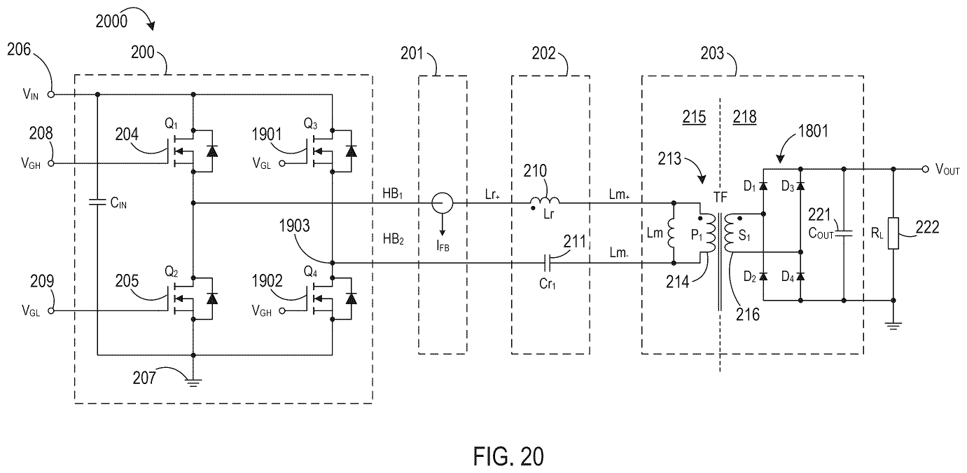

FIG. 20 illustrates an LLC converter 2000 with an alternative circuit for the voltage chopper 200 and for the output rectifier 203 compared with the LLC converter 105 illustrated in FIG. 2 according to an embodiment. The LLC converter 2000 includes the circuit arrangement of the voltage chopper 200 of FIG. 19 with the output rectifier 203 of FIG. 18.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly. the invention is not to be seen as limited by the foregoing description but is only limited by the scope of the appended claims.

1. A control circuit for a power converter including a plurality of power switches, a resonant network coupled with the plurality of power switches, and an output circuit coupled with the resonant network, the control circuit comprising:
a sampler configured to sample an output voltage provided by the output circuit to generate a sampled output voltage;
a feedback signal mixer configured to mix the sampled output voltage with a reference voltage to generate a mixed feedback signal;
an envelope controller configured to:
generate an envelope signal based on a sensed current flowing through the resonant network; and
generate a clock signal based on the mixed feedback signal and the envelope signal; and
a drive module configured to:
generate a plurality of drive signals based on the clock signal; and
control the plurality of power switches based on the plurality of drive signals.

2. The control circuit of claim 1, wherein the envelope controller comprises a signal processor configured to phase shift the sensed current to generate a phase-shifted signal based on the sensed current.

3. The control circuit of claim 2, wherein the envelope controller further comprises a sample-and-hold circuit configured to:
receive the generated clock signal as a feedback signal; and
sample and hold the phase-shifted signal based on the feedback signal to generate the envelope signal.

4. The control circuit of claim 3, wherein the envelope controller further comprises an envelope signal mixer configured to generate a mixed envelope signal based on the envelope signal and the mixed feedback signal.

5. The control circuit of claim 4, wherein the envelope controller further comprises:
a limiter configured to clamp a maximum value of the mixed envelope signal; and
a period register configured to clamp a period of the clamped mixed envelope signal.

6. The control circuit of claim 5, wherein the envelope controller further comprises a clock generator configured to generate the clock signal based on an output signal from the period register.

7. The control circuit of claim 4, wherein the envelope controller further comprises a filter configured to:
receive the envelope signal from the sample-and-hold circuit;
filter out any high-frequency signals from the envelope signal; and
supply the filtered envelope signal to the envelope signal mixer.

8. The control circuit of claim 1, wherein the envelope controller further comprises a filter configured to filter the mixed feedback signal; and
wherein the envelope controller is configured to generate the clock signal based on the filtered mixed feedback signal and the envelope signal.

9. A method for generating a plurality of control signals for a power converter comprising:
sampling an output voltage generated by an output circuit of the power converter;
generating a sampled output voltage based on the sampled output voltage;
mixing the sampled output voltage with a reference voltage;
generating a mixed feedback signal based on the mixed sampled output voltage;
generating an envelope signal based on a sensed current flowing through a resonant network of the power converter;
generating a clock signal based on the mixed feedback signal and the envelope signal; and
generating a plurality of drive signals based on the clock signal.

10. The method of claim 9 further comprising:
shifting a phase of the sensed current flowing through the resonant network; and
generating a phase-shifted signal based on the shifting of the phase of the sensed current.

11. The method of claim 10 further comprising:
receiving the clock signal as a feedback signal; and
sampling and holding the phase-shifted signal based on the feedback signal to generate the envelope signal.

12. The method of claim 11 further comprising generating a mixed envelope signal based on the envelope signal and the mixed feedback signal.

13. The method of claim 12 further comprising:
clamping a maximum value of the mixed envelope signal; and
clamping a period of the clamped mixed envelope signal.

14. The method of claim 13 further comprising generate the clock signal based on an output signal from the period register.

15. A power converter comprising:
a transformer comprising:
a primary winding coupled to a primary side of the power converter; and
a secondary winding coupled to a secondary side of the power converter;
a switching bridge circuit on the primary side and comprising:
a voltage input configured to receive a first voltage; and
a plurality of switches, each switch controllable into a conduction mode and into a non-conduction mode;
a resonant tank circuit on the primary side and coupled to the switching bridge circuit;
an output rectifier coupled to the secondary winding and comprising a voltage output configured to output an output voltage; and
a controller configured to:
sample the output voltage to generate a sampled output voltage;
mix the sampled output voltage with a reference voltage;
generate a mixed feedback signal based on the mixed sampled output voltage;
generate an envelope signal based on a sensed current flowing through the resonant tank circuit;
generate a clock signal based on the mixed feedback signal and the envelope signal; and
generate a plurality of drive signals based on the clock signal to control the conduction modes of the plurality of switches.

16. The power converter of claim 15, wherein the controller is further configured to:
shift a phase of the sensed current flowing through the resonant tank circuit; and
generate a phase-shifted signal based on the shifting of the phase of the sensed current.

17. The power converter of claim 16, wherein the controller is further configured to:
receive the clock signal as a feedback signal; and
sample and hold the phase-shifted signal based on the feedback signal to generate the envelope signal.

18. The power converter of claim 17, wherein the controller is further configured to generate a mixed envelope signal based on the envelope signal and the mixed feedback signal.

19. The power converter of claim 18, wherein the controller is further configured to:
clamp a maximum value of the mixed envelope signal; and
clamp a period of the clamped mixed envelope signal.

20. The power converter of claim 19, wherein the controller is further configured to generate the clock signal based on an output signal from the period register.
